(19) United States
(12) Patent Application Publication
(10) Pub. No.: US 2008/0216403 A1
(43) Pub. Date: Sep. 11, 2008

(54) STACKABLE PLANT GROWING TOWER SYSTEM

(76) Inventors: John Schmidt, Delta (CA); Johnson Ling, Richmond (CA); Paul Wu, Richmond (CA)

Correspondence Address: NEXUS LAW GROUP LLP, 1500 - 701 WEST GEORGIA STREET, VANCOUVER, BC, V7Y 1C6, CA

(21) Appl. No.: 11/683,344

(22) Filed: Mar. 7, 2007

(51) Int. Cl. A01G 9/02

(52) U.S. Cl. 47/83

(57) ABSTRACT

According to the present invention there is provided a stackable and nesting plant-growing container system for a growing medium. The system includes a first growing medium unit and a substantially identical second growing medium unit. The first and second units are each of a unitary construction and includes a sidewall. The sidewall includes an inner side and an outer side, a top edge and a bottom edge. The sidewall includes at least one primary lobe extending from the cross-sectional circumference of the sidewall and uniformly increases in diameter as its distance from the bottom edge of the side wall increases and terminates in the top edge and arranged with an outwardly curving inner side extending outside the growing medium units. The bottom edge includes a notched portion and the top edge includes a corresponding support portion arranged to align with the notched portion such that the notched portion of the second unit may be removably inserted into the first unit support portion so that the notched portion positions and supports the second growing medium unit above the first growing medium unit.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to the field of plant husbandry and in particular to a plant growing medium container or receptacle with both commercial and home gardening uses. The invention allows control of the growing medium used for the plants, and it provides stability of a vertical array of the containers when stacked to increase plant yield in a given growing space. The containers are easily transported in a compact nested configuration, but are quickly and easily filled with growing medium and stacked for use.

### BACKGROUND OF THE INVENTION

Vertically arranged growing containers are found in the prior art. Recent examples are U.S. Pat. No. 5,555,676 (Lund), U.S. Pat. No. 5,428,922 (Johnson), and U.S. Pat. No. 5,363,594 (Davis). Such prior art containers or container systems present the user with a variety of difficulties making them unsuitable for commercial use and difficult for home gardeners to use. Some containers are of large size making transport difficult and time consuming, others have so many differing parts that transport and assembly is inefficient, others are inefficient in the process of loading growing medium into the container, requiring the container be filled while assembled in a stack, or a time-consuming multi-step filling process is required. Some containers are inefficient in the use of growing medium, requiring a substantial volume of growing medium or a relatively large footprint of ground to support only a relatively small growing area exposed to light. Others have no provision to preclude plants on one level from interfering with growth of plants on adjacent levels.

There is a need for a plant growing container system that is labor efficient and allows control of the growing medium. Further, there is a need to reduce the amount of water and labor required to grow crops in a limited area. It is estimated that strawberry growers using his stacking container system can quadruple the number of plants per acre and obtain increased yield from each plant because the plants are hanging and not exposed to the pests and mold that commonly damages crops laying on wet ground.

The advantages of this invention apply not only to commercial horticulture, but equally to home gardeners. Many home gardeners have need for an easy-to-use stacking container system for situations where there is limited space and limited time to prepare a garden.

Other objects of the invention will be apparent from the description that follows.

### SUMMARY OF THE INVENTION

According to the present invention there is provided a stackable and nesting plant-growing container system for a growing medium. The system includes a first growing medium unit and a substantially identical second growing medium unit. The first and second units are each of a unitary construction and each include a sidewall. The sidewall includes an inner side and an outer side, a top edge and a bottom edge. The inner and outer sides of the sidewall may have a substantially circular cross-section. The sidewall also includes at least one primary lobe extending from the cross-sectional circumference of the sidewall or may include a plurality of primary lobes extending from the cross-sectional circumference of the sidewall. The primary lobe uniformly increases in diameter as its distance from the bottom edge of the side wall increases and terminates in the top edge and arranged with an outwardly curving inner side extending outside the growing medium units.

The bottom edge includes a notched portion and the top edge includes a corresponding support portion arranged to align with the notched portion such that the notched portion of the second unit may be removably inserted into the first unit support portion so that the notched portion positions and supports the second growing medium unit above said the growing medium unit.

The notched portion and the support portion may be are arranged to positionally offset a plurality of primary lobes of the second growing medium unit from the plurality of primary lobes of the first growing medium unit.

The sidewall may further include a plurality of secondary lobes adjacent the plurality of primary lobes. The secondary lobes may extend inwardly from the cross-sectional circumference of the sidewall and uniformly increase in diameter as its distance from the top edge of the sidewall increases and terminates in the bottom edge. The secondary lobes may be arranged with an inwardly curving inner side extending inside the growing medium units.

The secondary inwardly curving lobes may be are arranged so that the secondary lobes of the second growing medium unit is above the primary outwardly curving lobes of the first growing medium unit when the second unit rests atop the first unit.

The system may further include a perforated fluid conduit insertable through the cross-sectional circumference of the second and first growing medium units. The fluid conduit may be increasingly perforated from one end to the other.

A web structure may be connected at a first end to the sidewall of each respective unit. The web structure may converge inwardly from the cross-sectional circumference of the side wall and connected at a second end to a support structure, said support structure being adaptable to receive said fluid conduit.

The system may further include a pan connectable to the bottom edge of the first growing medium unit for holding the growing medium from falling through the first unit. The system may further include a plurality of containers removably supported in a container stack.

In accordance with another embodiment of the invention, there is provided a stackable horticultural apparatus. The apparatus may include a plurality of multi-lobed growing medium units removably connected in a vertical array, each unit of substantially identical construction comprising a sidewall, said sidewall comprising an inner side and an outer side, a top edge and a bottom edge.

The sidewall may include a plurality of primary lobe extending from the cross-sectional circumference of the sidewall, each of the plurality of primary lobes uniformly increases in diameter as its respective distance from the bottom edge of the sidewall increases and terminates in the top edge and arranged with an outwardly curving inner side extending outside the growing medium units

The bottom edge may include a notched portion and the top edge may include a corresponding support portion arranged to align with the notched portion such that the notched portion of the second growing medium unit may be removably inserted into the first growing medium unit support portion so that the notched portion positions and supports the second unit above the first unit.

The units are arranged such that when a second identical unit fits into a first unit, the first unit's inner side surface contacts the second unit's outer side surface substantially from the bottom to the top edges.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a top isometric view of a preferred embodiment of a single unit of the stackable plant growing tower system;

FIG. 2 is a bottom isometric view of the preferred embodiment of the single unit of FIG. 1;

FIG. 3 is a top view of the preferred embodiment of the single unit of FIG. 1;

FIG. 4 is a side view of the preferred embodiment of the single unit of FIG. 1;

FIG. 5 is a bottom view of the preferred embodiment of the single unit of FIG. 1;

FIG. 6 is an isometric top view of the preferred embodiment of the stackable plant growing tower system in an array of 4 stacked units;

FIG. 7 is an isometric top view of the preferred embodiment of 13 units nested one-inside-the other for transport; and

FIG. 8 is side view of the preferred embodiment of the stackable plant growing tower system in the array of 4 stacked units of FIG. 6.

### DESCRIPTION OF THE PREFERRED EMBODIMENT OF THE INVENTION

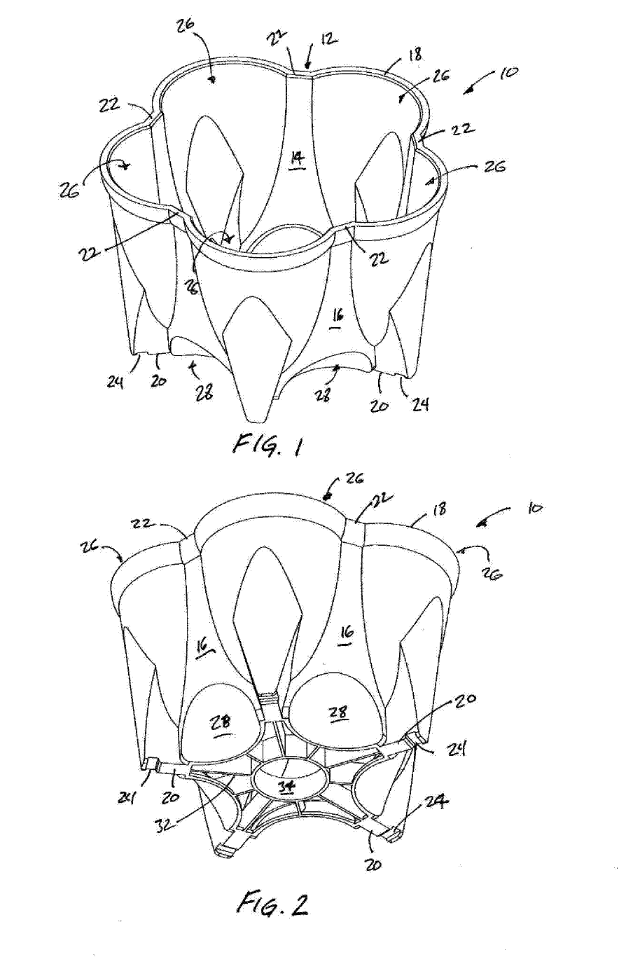

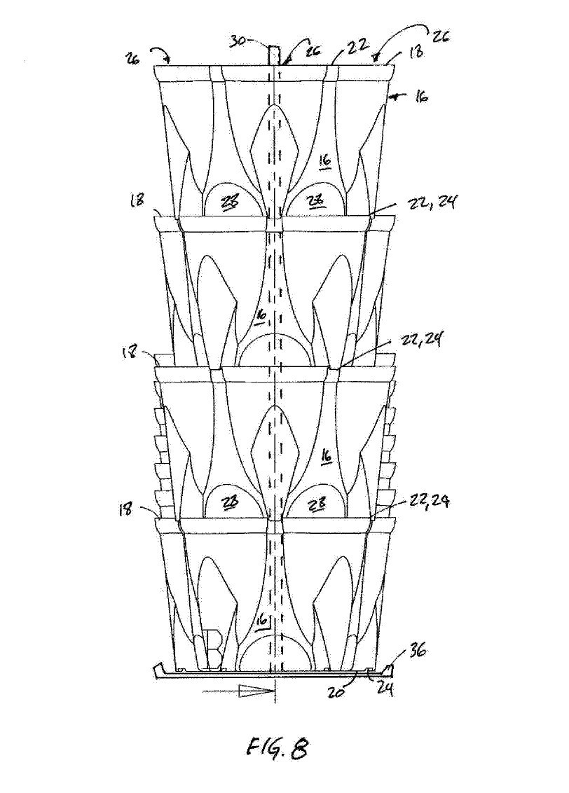

FIGS. 1 through 8 show the preferred embodiment of the stackable plant growing tower system. In this embodiment, individual one-piece units, as shown in FIGS. 1-5, can be arranged in a vertical stack as shown in FIGS. 6 and 8, yet may be nested together for shipping as shown in FIG. 7.

Referring to FIGS. 1 and 2 a growing medium unit 10 of the stackable plant growing tower system is illustrated. Unit 10 is of unitary construction and includes a sidewall 12 preferably having a circular cross-section. The sidewall 12 has an inner side 14, an outer side 16, a top edge 18 and a bottom edge 20.

When stacked as illustrated in FIGS. 6 and 8, the bottom edge 20 of the lowest unit rests on level ground and lower growing units support upper growing units above at the top edge support portion 22. Both vertical and lateral support is provided to an upper growing unit by the lower unit top edge support portion 22, by virtue of having a bottom edge notched portion 24 of an upper growing unit removably inserted into each lower unit top edge support portion 22.

The bottom edge notched portion 24 are cast integral with the bottom edge 20. In this embodiment, the notched portion 24 are rectangularly shaped to match with the dimensions of top edge support portion 22. As those skilled in the art will appreciate, the cross-section of bottom edge notched portion 24 may also be in any of a number of corresponding geometric shapes to match with top edge support portion 22.

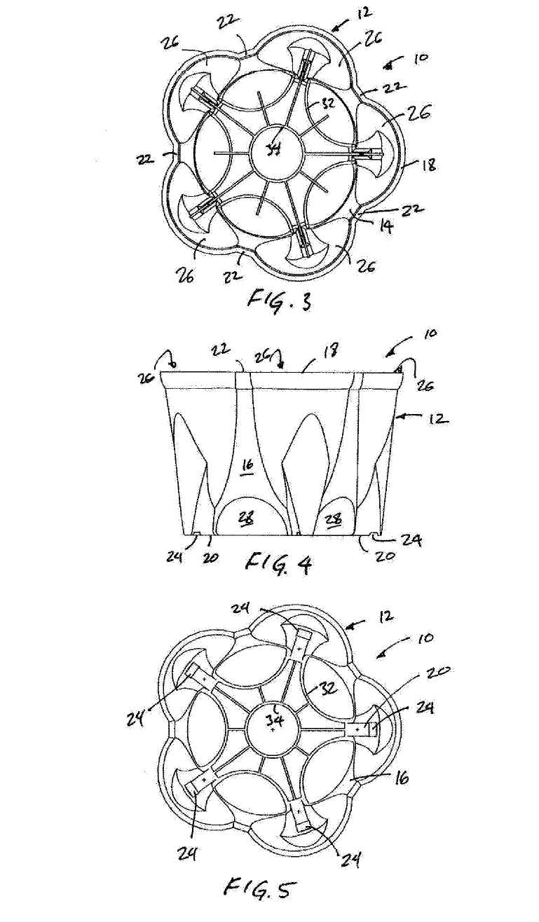

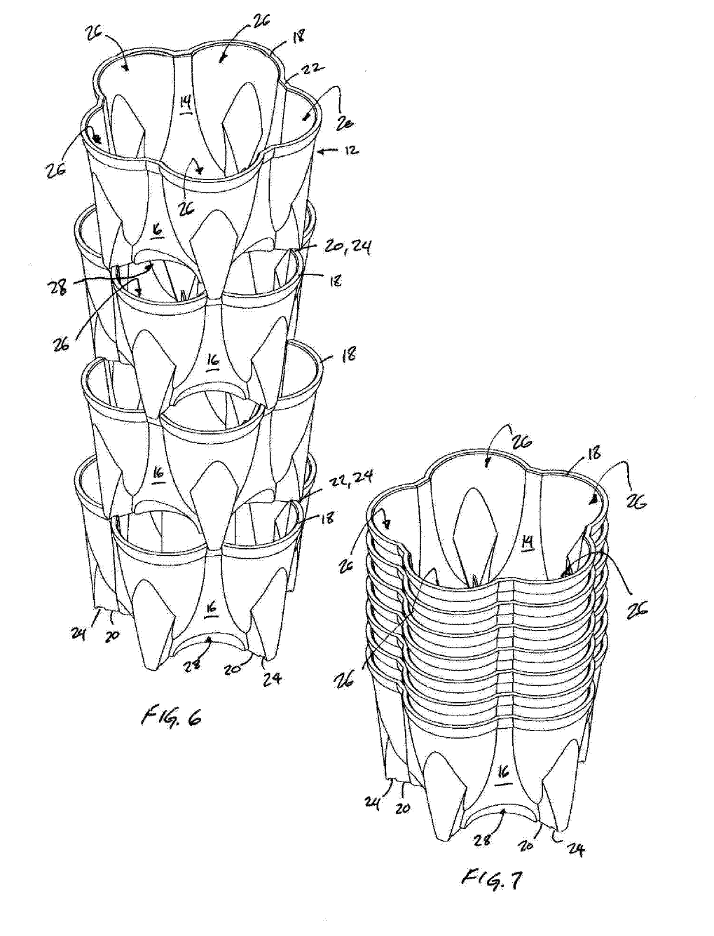

Referring to FIGS. 3 and 5, an imaginary circle might be drawn through the center of the top edge support portion 22 and the center of the bottom edge notched portion 24. The spacing about this imaginary circle is the same for both the support portion 22 and notched portion 24. This permits simultaneous insertion of all notched portions 24 atop all the support portions 22, fixing the azimuthal orientation of each upper growing unit in relation to the lower growing unit. This provides an apparatus of stacked units, as shown in FIGS. 6 and 8, with the notched portions 24 of each growing unit inserted into the support portions 22 of the next lower growing unit.

In the preferred embodiment, growing unit side wall 12 has 5 primary flared-lobes 26 as best shown in FIG. 1. The primary flared-lobe sections 26 are symmetrically spaced about the circumference of the growing unit 10 and may be integrally formed with the unit. More pairs of lobes, or non-symmetrical lobes, may be used to provide smaller lobe sizes in relation to the unit size, in order to optimize the unit 10 for differing plant sizes. Each primary lobe flares outward with a uniform increase in distance from the bottom edge 20 and terminating in the top edge 18. In nesting growing units, as illustrated in FIG. 7, a substantial part of one unit's outer side wall 16 will fit inside a second unit's inner side wall 14. Nesting allows for compact transport of multiple containers.

In the preferred embodiment, growing unit side wall 12 has 5 secondary offset flared-lobes 28 as best shown in FIG. 2. The secondary offset flared-lobes sections 28 are symmetrically spaced about the circumference of the growing unit 10, are offset from from the primary flared-lobes 26 and may be integrally formed with the unit. More pairs of lobes, or non-symmetrical lobes, may be used to provide smaller lobe sizes in relation to the unit size, in order to optimize the unit for differing plant sizes. Each secondary lobe flares inward with a uniform increase in distance from the top edge 18 and terminating in the bottom edge 20.

When stacked, as shown in FIG. 6, the arrangement of the bottom edge notched portion 24 and top edge support portion 22 orients the stacked growing unit system such that a flared primary lobe section 26 of one growing unit 10 is directly below a flared secondary lobe of the next higher growing unit. This configuration provides additional volume above primary flared-lobes 26 to allow for additional sunlight exposure to the growing medium and to allow for additional space for a plant to grown in.

As illustrated in FIG. 8, for irrigation purposes, the system 10 may include a perforated fluid conduit 30 insertable through the cross-sectional circumference of the stackable growing medium units 10. Preferably, fluid conduit 30 is increasingly perforated from the top to the bottom so that fluid is more evenly distributed by gravity throughout the array of units 10. Fluid conduit 30 may be single conduit extending the length of the array. Alternatively, conduit 30 may be comprised of several identical conduit pieces attached together. Each individual conduit piece could then be separately packaged with an individual growing medium unit 10.

Additionally, the plant-growing container system may further include a pan 36 connectable to the bottom edge 20 of a growing medium unit 10 for holding the growing medium from falling through the first unit 10.

As illustrated in FIGS. 2, 3 and 5, the stackable and nesting plant-growing system may further include a web structure 32 connected at a first end to the sidewall 12. The web structure 32 may converge inwardly from the the side wall 12 and be connected at a second end to a support structure 34. The support structure 34 may simply be a ring adaptable to receive the fluid conduit 30.

Operation

Growing medium may be first placed into a first growing unit 10. If desired, planting of the seed or seedlings may be done prior to or after positioning the unit 10. A second unit may then be placed above the first unit so that bottom edge notched portion 24 of the second unit and top edge support portion 22 of the first unit are aligned. Once aligned, the second unit is then pressed into position onto the base unit. The second unit is now prepared to receive growing medium as with first unit. This process is repeated for a stack of containers as tall as desired. As the unit 10 is has an open bottom, several units may be first stacked together and then growing medium added to the array.

If desirable for indoor applications, the pan 36 may be placed underneath the first unit to capture the growing medium and to prevent the growing medium from spoiling the indoor surface.

Furthermore, if desirable, before the growing medium is placed within a unit or an array of units, the fluid conduit 30 may be inserted into the support structure 34 to provide for irrigation. Growing medium may then be placed into the unit or array such that it surrounds the fluid conduit.

It will thus be seen that a new and novel stackable and nesting plant-growing container system has been illustrated and described and it will be apparent to those skilled in the art that various changes and modifications may be made therein without departing from the spirit of the invention.

What is claimed is:

1. A stackable and nesting plant-growing container system for a growing medium comprising:
a first growing medium unit and a substantially identical second growing medium unit, said first and second units each of a unitary construction and comprising a sidewall, said sidewall comprising an inner side and an outer side, a top edge and a bottom edge;
said sidewall comprising at least one primary lobe extending from the cross-sectional circumference of said sidewall, said primary lobe uniformly increasing in diameter as its distance from said bottom edge of said side wall increases and terminates in said top edge and arranged with an outwardly curving inner side extending outside said growing medium units; and
said bottom edge comprising a notched portion and said top edge comprising a corresponding support portion arranged to align with said notched portion such that said notched portion of said second unit may be removably inserted into said first unit support portion so that said notched portion positions and supports said second growing medium unit above said first growing medium unit.

2. The stackable and nesting plant-growing container system of claim 1 further comprising a plurality of primary lobes extending from the cross-sectional circumference of said sidewall.

3. The stackable and nesting plant-growing container system of claim 2 wherein said notched portion and said support portion are arranged to positionally offset said plurality of primary lobes of said second growing medium unit from the plurality of primary lobes of said first growing medium unit.

4. The stackable and nesting plant-growing container system of claim 3 wherein said sidewall comprises a plurality of secondary lobes adjacent said plurality of primary lobes, said secondary lobes extending inwardly from the cross-sectional circumference of said sidewall and uniformly increasing in diameter as its distance from said top edge of said sidewall increases and terminates in said bottom edge, said secondary lobes arranged with an inwardly curving inner side extending inside said growing medium units.

5. The stackable and nesting plant-growing container system of claim 4 wherein said secondary inwardly curving lobes are arranged so that said secondary lobes of said second growing medium unit is above said primary outwardly curving lobes of said first growing medium unit when said second unit rests atop said first unit.

6. The stackable and nesting plant-growing container system of claim 1 further comprising a perforated fluid conduit insertable through said cross-sectional circumference of said second and first growing medium units.

7. The stackable and nesting plant-growing container system of claim 6 further comprising a web structure connected at a first end to said sidewall, said web structure converging inwardly from said cross-sectional circumference of said side wall and connected at a second end to a support structure, said support structure being adaptable to receive said fluid conduit.

8. The stackable and nesting plant-growing container system of claim 6 wherein said fluid conduit is increasingly perforated from one end to the other.

9. The stackable and nesting plant-growing container system of claim 1 further comprising a pan connectable to said bottom edge of said first growing medium unit for holding the growing medium from falling through said first unit.

10. The stackable and nesting plant-growing container system of claim 1 wherein said inner and outer sides of said sidewall comprises a substantially circular cross-section.

11. A stackable and nesting plant-growing container system of claim 1 further comprising a plurality of containers removably supported in a container stack.

12. A stackable horticultural apparatus comprising:
a plurality of multi-lobed growing medium units removably connected in a vertical array, each unit of substantially identical construction comprising a sidewall, said sidewall comprising an inner side and an outer side, a top edge and a bottom edge;
said sidewall comprising a plurality of primary lobes extending from the cross-sectional circumference of said sidewall, each of said plurality of primary lobes uniformly increases in diameter as its respective distance from said bottom edge of said sidewall increases and terminates in said top edge and arranged with an outwardly curving inner side extending outside said growing medium units;
said bottom edge comprising a notched portion and said top edge comprising a corresponding support portion arranged to align with said notched portion such that said notched portion of said second growing medium unit may be removably inserted into said first growing medium unit support portion so that said notched portion positions and supports said second unit above said first unit;
said growing medium units are arranged such that when a second identical unit fits into a first unit, said first unit's inner side surface contacts said second unit's outer side surface substantially from said bottom to said top edges.

13. A stackable and nesting plant-growing container system as hereinbefore described with reference to the accompanying drawings.
